(19) United States
(12) Patent Application Publication
(10) Pub. No.: US 2023/0249687 A1
(43) Pub. Date: Aug. 10, 2023

(54) TIGHT TURN WHEEL LOCKING

(71) Applicant: Zimeno, Inc. dba Monarch Tractor, Livermore, CA (US)

(72) Inventors: Zachary Meyer OMOHUNDRO, Livermore, CA (US); Karan KAUSHIK, Dublin, CA (US); Matthew Michael O'BRIEN, Livermore, CA (US); Akash MODI, Livermore, CA (US)

(73) Assignee: Zimeno, Inc. dba Monarch Tractor, Livermore, CA (US)

(21) Appl. No.: 18/164,454

(22) Filed: Feb. 3, 2023

Related U.S. Application Data
(60) Provisional application No. 63/307,016, filed on Feb. 4, 2022.

(51) Int. Cl. B60W 30/18; B60W 10/184; B60W 10/16

(52) U.S. Cl. CPC B60W 30/18145; B60W 10/16; B60W 10/184; B60W 2300/152; B60W 2510/202; B60W 2510/207; B60W 2520/10; B60W 2530/203; B60W 2540/18; B60W 2552/35; B60W 2710/125; B60W 2710/207

(57) ABSTRACT

A tight turn wheel locking system may include a steering end stop sensor to output signals indicating that steered front wheels of a vehicle are in an end stop state towards a short turn side, an end stop steering wheel input sensor to output signals indicating end stop operator input to the steering wheel while the steered front wheels are in the end stop state, and a controller configured to automatically enter a tight turn mode in response to the end stop operator input satisfying a predetermined threshold. The controller, in the tight turn mode, outputs tight turn control signals that cause a vehicle braking system of the vehicle to lock a rear wheel of the vehicle corresponding to the short turn side.

### CROSS-REFERENCE TO RELATED PATENT APPLICATIONS

The present non-provisional patent application claims priority under 35 USC 119 from co-pending U.S. Provisional Pat. Application Serial No. 63307016 filed on Feb. 4, 2022 by Omohundro et al. and entitled TIGHTER TURN SPLIT BRAKING, the full disclosure of which is hereby incorporated by reference.

### BACKGROUND

Vehicles are often steered so as to turn the vehicle. The angle or sharpness of a turn may be dependent upon the maximum angle at which the front steered wheels of the vehicle may be turned. With some vehicles, such as tractors, the inability to execute sufficiently sharp turns, such as at the end of a crop row, may result in longer, less efficient and more costly field operations.

### BRIEF DESCRIPTION OF THE DRAWINGS

FIG. 1 is a diagram schematically illustrating portions of an example Tight turn wheel locking system for an example vehicle.

FIG. 2 is a flow diagram of an example method that may be carried out by the example Tight turn wheel locking system of FIG. 1.

FIG. 3A is a diagram schematically illustrating operation of the example vehicle of FIG. 1 in a linear travel mode.

FIG. 3B is a diagram schematically illustrating operation of the example vehicle of FIG. 1 in a wheel turning mode.

FIG. 3C is a diagram schematically illustrating operation of the example vehicle of FIG. 1 in a tight turn mode in which the short turn side rear wheel is locked while the vehicle is moving forward.

FIG. 4 is a top perspective view of an example vehicle, in the form of a tractor, comprising an example tight turn wheel locking system, with portions being schematically illustrated.

FIG. 5 is a bottom view of the example vehicle of FIG. 4 with portions being schematically illustrated.

FIG. 6 is a diagram illustrating portions of propulsion system of the vehicle of FIG. 4.

FIG. 7 is a flow diagram of an example method that may be carried out by the example vehicle of FIG. 4.

Throughout the drawings, identical reference numbers designate similar, but not necessarily identical, elements. The FIGS. are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example systems, vehicles and methods for executing sharper or tighter turns. The example systems, vehicles and methods may operate in a tight turn mode that locks a rear wheel on a short turn side to achieve such sharper or tighter turns.

For purposes of this disclosure, the short turn side of the vehicle is defined as the side of the vehicle facing the direction in which the vehicle is to be turned. For example, the short turn side of vehicle being turned to the left is the left side of the vehicle. The short turn side of the vehicle being turned to the right is the right side of the vehicle. “Left” and “right” refer to directions from the perspective of a real or imaginary forward-facing operator residing on the vehicle.

By locking the short turn side rear wheel of the vehicle, the vehicle is able to pivot or skid about a pivot axis defined by the locked short turn side rear wheel. This tight turn mode achieves a sharper turn that may exceed the maximum angle at which the steered front wheels may be turned. As a result, less time is spent executing such turns, such as at the end of a crop row, reducing the time and costs associated with a field operation.

The example systems, vehicles and methods automatically enter the tight turn mode based upon sensed interactions of the vehicle operator with the vehicle steering wheel. As result, the vehicle operator may more easily switch the vehicle to the tight turn mode without having to disengage the steering wheel or refocus his or her attention from the field or terrain about to be traversed by the vehicle. In addition, the example systems, vehicles and methods may further facilitate faster switching to the tight turn mode, allowing more responsive and more timely tighter turns.

The example systems, vehicles and methods automatically enter the tight turn mode based upon a determination that the front steered wheels are in an end stop state and based upon the aforementioned sensed interactions of the vehicle operator with the vehicle steering wheel. For purposes of this disclosure, the term “end stop state” or “end stop position” refers to the front steered wheels of a vehicle being a state or position at which the front steered wheels are not further rotatable or steerable further towards the short turn side. A left turn end stop state refers to the state of the front steered wheels being no longer further steerable or rotatable towards or to the left. A right turn end stop state refers to the state of the front steered wheels being no longer further steerable or rotatable towards or to the right. The sensed operator interactions with the steering wheel are those interactions that occur after or while the steered front wheels are in an end stop state towards a short turn side.

The sensed operator interaction with the steering wheel while the steered front wheels are in an end stop state comprises an end stop operator input. This end stop operator input is compared to at least one predetermined threshold to determine whether the at least one predetermined threshold is satisfied. If at least one predetermined threshold is satisfied by the end stop operator input, the example systems, vehicles and methods automatically enter a tight turn mode. The tight turn mode comprises locking a rear wheel of the vehicle corresponding to the short turn side.

The example systems, vehicles and methods may comprise or utilize a steering end stop sensor that is configured to output signals indicating that steered front wheels of a vehicle are in an end stop state towards the short turn side. The example systems, vehicles and methods may comprise or utilize an end stop steering wheel input sensor to output signals indicating end stop operator input to the steering wheel while the steered front wheels are in the end stop state. The example systems, vehicles and methods may further comprise a controller that is configured to automatically enter a tight turn mode in response to the end stop operator input satisfying a predetermined threshold. In the tight turn mode, the controller outputs tight turn control signals that cause a vehicle braking system of the vehicle to lock the rear wheel of the vehicle corresponding to the short turn side.

In some implementations, the steering end stop sensor comprises a sensor configured to directly sense in angular positioning of the steered front wheels. Such a sensor may involve one or more sensing elements. In some implementations, the steering end stop sensor may comprise a sensor that senses a continuum of different possible angular positions of the steered front wheels between a left turn end stop state and a right turn end stop state. One example of such a sensor is a potentiometer.

In some implementations, the end stop steering end stop sensor may comprise a sensor that simply detects when the steered front wheels are at either of the left turn end stop state or the right turn end stop state. For example, such a steering end stop sensor may comprise a left contact switch for outputting signals when the steered front wheels are at a left turn end stop state and a right contact switch for outputting signals when the steered front wheels are at a right turn end stop state.

In some implementations, the steering end stop sensor may comprise a sensor that indirectly senses when the steered front wheels are at an end stop state, either a left turn end stop state, or a right turn end stop state. For example, between and including the left end stop state and the right end stop state of the steered front wheels, the angular positioning of the steering wheel may directly correspond to or be mapped to the angular positioning of the steered front wheels. In some implementations, the steering end stop sensor may comprise a sensor that directly senses an angular positioning of the steering wheel, thereby indirectly sensing the positioning of the steered front wheels and outputting signals that may indicate whether the steered front wheels are at either of the left turn end stop state or the right turn end stop state. In yet other implementations, the angular positioning of the steered front wheels and the determination of whether the steered front wheels are at either of the left end stop state or the right end stop state may be based upon other sensors that may directly or indirectly sense the angular positioning of the front steered wheels.

In some implementations, the rotational resistance of the steering wheel further towards the short turn side is increased in response to the steered front wheels of the vehicle being in the end stop state.

In some implementations, the steering wheel is manually rotatable by a further amount against the rotational resistance while steered front wheels are in an end stop state. In such an implementation, the end stop steering wheel input sensor is configured to sense a velocity (or other angular rate of movement derived from the velocity) at which the steering wheel is rotated while the steered front wheels are in the end stop state. In such an implementation, the end stop operator input that is compared to the predefined threshold comprises the sensed velocity.

In some implementations, the steering wheel is manually rotatable by a further amount against the rotational resistance to a new angular position further towards the short turn side while the steered front wheels remain in the end stop state. In such an implementation, the end stop steering wheel input sensor is configured to sense positioning of the steering wheel. The end stop operator input comprises the positioning of the steering wheel and the predetermined threshold comprises the new position.

For example, an operator may turn the steering wheel in a direction to a first position corresponding to the steered front wheels being in an end stop state towards the short turn side. Although the steering will may be further rotatable in the same direction, the operator may experience an increased amount of resistance against such additional rotation or turning of the steering wheel. Such additional resistance may tactically indicate to the operator that further sharpening the turning angle of the vehicle by turning the front steered wheels is no longer available. Such additional resistance may indicate to the operator that any further rotation of the steering wheel against the additional resistance is for the purpose of providing input to the vehicle to cause the vehicle to enter into the tight turn mode. To trigger the tight turn mode, the operator may continue to turn the steering wheel in the same direction towards the short turn side, against the additional resistance, to a new second position beyond the first position. Turning of steering wheel to the second position, against the increased turning resistance, results in the tight turn mode being automatically entered.

In some implementations, the additional rotational resistance applied to the steering wheel upon the steered front wheels attaining an end stop state may prevent any further turning or rotation of the steering wheel towards the current short turn side. In some implementations, the additional rotational resistance to further turning of the steering wheel once the steered front wheels have attained the end stop position may be in the form of a simple mechanical end or stopping point. In other implementations, a nonmechanical rotational resistance (e.g., magnetic field or force) may be applied to an extent sufficient to block or impede any further manual turning or rotation of the steering wheel further towards the short turn side. In such implementations, the operator may continue to apply force or rotational torque to the steering wheel while the front steered wheels are in the end stop state (while the steering wheel can no longer be further turned or rotated towards the short turn side). Such force will not result in further turning of the steering wheel. However, such force may be sensed, such as with a strain sensor. In such an implementation, the end stop operator input comprises this sensed force. The predetermined threshold may comprise a force value for triggering entry into the tight turn mode.

In some implementations, the example systems, vehicles and methods may provide additional or alternative notifications to the operator that the steered front wheels are in an end stop state. For example, in some implementations, the example systems, vehicles and methods may vibrate the steering wheel, output a visual indicator and/or output an audible indicator informing the operator that the steered front wheels have attained an end stop state. In such an implementation, any further operator input to the steering wheel towards the short turn side (the additional turning of the steering wheel towards the short turn side or the application of force to a steering wheel that can be no longer be rotated further towards the short turn side) may cause the vehicle to automatically enter a tight turn mode. In some implementations, where such alternative notifications are provided to the operator, the example systems, vehicles and methods may omit the automatic increase in rotational resistance applied to the steering wheel in response to the steered front wheels attaining an end stop state.

In some implementations, the tight turn mode may involve additional operational adjustments. For example, upon entry into the tight turn mode, the speed of the non-short turn side rear wheel may be incremented to further increase the speed of the short turn. In some implementations, the vehicle may be equipped with a rear axle differential that automatically doubles the speed of the non-short turn side rear wheel in response to locking of the short turn side rear wheel.

In some implementations, the vehicle may be equipped with a front wheel overdrive system, wherein the front wheels of the vehicle may be provided with an adjustable lead. Said another way, the front wheels may have rotational speed that may be varied relative to the rotational speed at which the rear wheels or wheel are being driven. Upon entry into the tight turn mode, the rotational speed of the front wheels may be increased relative to the speed at which the non-short turn side rear wheel is being driven.

In some implementations, entry of the vehicle into the tight turn mode may be further predicated upon the current speed of the vehicle. For example, the speed of the vehicle may be sensed or otherwise determined. In circumstances where the speed of the vehicle is greater than a predetermined vehicle speed threshold, entry of the vehicle into the tight turn mode may be prevented. This may reduce the likelihood of vehicle overturn. In some implementations, the vehicle operator may be notified that for the tighter turn mode to be entered, the speed of the vehicle should be reduced.

In some implementations, entry of the vehicle into the tight turn mode may be additionally based upon the type of implement or attachment connected to the vehicle. The vehicle may include a sensor that detects and determines parameters or characteristics of the implement/attachment or may present a prompt for the vehicle operator to indicate the type or characteristics of the implement/attachment. In such implementations, entry into the tight turn mode by a vehicle, such as a tractor, may be prevented in response to a determination that the vehicle is pulling a particular type of attachment or implement. For example, the particular type or attachment may have an insufficient drawbar length for such a tight turn mode.

In some implementations, entry of the vehicle into the tight turn mode may be additionally based upon the type of operation currently being carried out by the vehicle or any attachments/implements. The vehicle may include a sensor that outputs signals allowing a controller to detect the type of operation being carried out by the vehicle or any attachments/implements. In some implementations, the vehicle may present a prompt to the vehicle operator, wherein the vehicle operator provides an input indicating the type of operation being carried out. In such implementations, entry into the tight turn mode by a vehicle, such as a tractor, may be prevented in response to a determination that the vehicle or its implement are carrying out a particular type of operation that might present safety concerns upon entry of the tight turn mode. For example, in some implementations, entry into the tight turn mode by the vehicle may be prevented in response to determination that the current type of operation is at a rate or speed too high for entry into the tight turn mode. In some implementations, the operation of an attachment or implement may be the height at which at least portions of the attachment or implement are currently being supported by the vehicle, wherein entry of the vehicle into the tight turn mode may be based upon or dependent upon the current height of the attachment or implement. For example, an implement may be supported at too great of a height relative to the ground or relative to the vehicle for a tight turn mode to be implemented such that entry into the tight turn mode is automatically stopped or a notification is provided to the operator, the notification recommending that the tight turn mode not be entered. In some implementations, the vehicle may provide the vehicle operator with a notice providing the reason for the vehicle not entering the tight turn mode or may suggest to the operator that the speed, rate of the operation or height of the implement be reduced to allow entry into the tight turn mode.

In some implementations, entry of the vehicle into the tight turn mode may be additionally based upon the current type or characteristics of the underlying terrain on which the short turn side rear wheel is to skid during such a tight turn. Entry of the vehicle into the tight turn mode made to be dependent upon the type of soil and/or the moisture content of the underlying soil. The type of soil may be obtained directly from operator input or may be acquired using global positioning system (GPS) signals acquired by the vehicle and indicating the current position of the vehicle in combination with map data associating particular soil types or conditions with the current location of the vehicle. Such maps may be stored on the vehicle or may be obtained in a wireless fashion from remote servers or sources. In some implementations, the vehicle may utilize sensors, such as cameras, carried by the vehicle for evaluating the type and current condition of the underlying soil or terrain.

In some implementations, entry of the vehicle into the tight turn mode may be additionally based upon the current orientation of the vehicle, the current pitch and/or roll of the vehicle. For example, entry into the tight turn mode may be blocked in circumstances where the vehicle has a pitch exceeding a predetermined pitch threshold to reduce likelihood of the vehicle overturning.

The current pitch or roll of the vehicle may be obtained directly from operator input or may be acquired using an inertial motion unit carried by the vehicle that output signals that indicate the current orientation of the vehicle. In some implementations, the slope of the underlying terrain, which may correspond to or impact the pitch or roll of the vehicle, may be determined based on the GPS signals and topographical maps. Such maps may be stored on the vehicle or may be obtained in a wireless fashion from remote servers or sources. In some implementations, the vehicle may utilize sensors, such as cameras, carried by the vehicle for determining the pitch or roll of the vehicle.

In each of the aforementioned examples, in lieu of prohibiting or preventing entry of the vehicle into the tight turn mode, such conditions may alternatively be used by the vehicle as a basis for controlling the adjusted speed of the non-short turn side rear wheel, the incremental or adjusted the speed of the front wheels during the tight turn mode, and/or speed of the vehicle during such a tight turn. For example, the current implement/attachment of the vehicle, the current operation of the vehicle and such or implement/attachment and/or the current type or characteristics of the underlying terrain may each be used as a basis for adjusting the speed of the non-short turn side rear wheel or the adjustment of the speed of the front wheels during the tight turn mode. In some implementations, the speed of the vehicle itself, although below the vehicle speed threshold (discussed above) may be used by the vehicle (system) as a basis for determining the increased speed of the non-short turn side rear wheel or the overdrive state of the front wheels. In some circumstances, the speed of the turning in the tight turn mode, such as the rotational speed of the non-short turn side rear wheel or the overdriven front wheels, may be based on the current pitch or roll of the vehicle. In some implementations, such conditions may automatically cause the controller to reduce a speed of the vehicle or may cause the operator to be notified that the speed of the vehicle should be reduced given the particular circumstances.

In some implementations, rotation of the steering wheel away from the short turn side may automatically result in the vehicle exiting the tight turn mode. In some implementations, exiting the tight turn mode may be achieved in other fashions. For example, a separate input device may be utilized to receive vehicle operator input requesting exit from the tight turn mode.

Upon exiting the tight turn mode, the short turn side rear wheel may be unlocked, wherein power or torque is transmitted to the short turn side rear wheel and the short turn side rear wheel is rotated or propelled. In some implementations, upon exiting the tight turn mode, any previously applied increased rotational resistance to the steering wheel is reduced or returned to a default (non-tight turn mode) condition. In some implementations, such exiting may further result in the speed of the non-short turn side rear wheel being reduced so as to match the reinstituted rotational speed of the short turn side rear wheel. In some implementations, the rotational speed of the front wheels may likewise be reduced upon the vehicle exiting the tight turn mode.

For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

For purposes of this disclosure, the phrase “configured to” denotes an actual state of configuration that fundamentally ties the stated function/use to the physical characteristics of the feature proceeding the phrase “configured to”.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

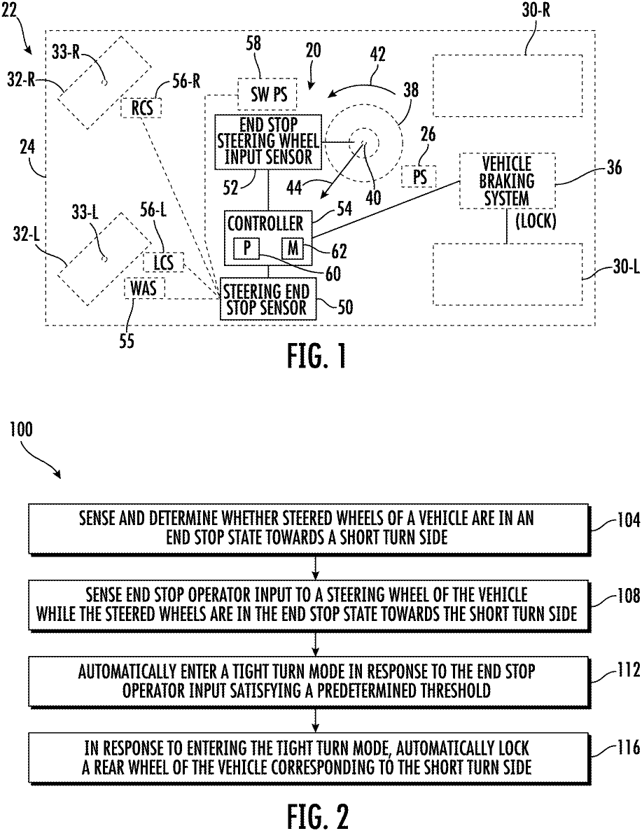

FIG. 1 is a diagram of a tight turn wheel locking system 20 that may be added to an existing vehicle or that may be incorporated into the manufacture of a vehicle 22 (shown in broken lines). Vehicle 22 may comprise frame 24, propulsion system 26, rear wheels 30-R, 30-L (collectively referred to as rear wheels 30), front wheels 32-R, 32-L (collectively referred to as front wheels 32), vehicle braking system 36 and steering wheel 38.

Frame 24 comprises a structure supporting the remaining components of vehicle 22. Propulsion system 26 comprises the mechanism of vehicle 22 configured to propel or drive vehicle 22 in a forward direction or reverse direction, depending upon a state of an associated transmission. Propulsion system 26 may rely upon stored electrical energy, generated electrical energy and/or mechanical energy derived from an internal combustion engine. Propulsion system 26 may comprise at least one battery and at least one electric motor for propelling vehicle 22. Propulsion system 26 may comprise at least one hydraulic pump and at least one hydraulic motor for propelling vehicle 22, wherin the pump is driven by an electric motor or an internal combustion engine. Propulsion system 26 may comprise an internal combustion engine. Propulsion system 26 may comprise a full electric drive, wherein an electric motor supplies torque directly to the driven wheels by a transmission.

Rear wheels 30 extend at a rear portion of frame 24 of vehicle 22 and are not steerable. Front wheels 32 extend at a front portion of the frame 24 and are steerable in response to rotation of steering wheel 38.

Front wheels 32-R, 32-L are rotatably supported by the frame for rotation about pivot axes 33-R, 33-L, respectively. Front wheels 32 are steerable about axes 33-R, 33-L (collectively referred to as axes 33) in response to turning of steering wheel 38. Front wheels 32 are rotatable or steerable about axes 33 between left and right end stop states. In the left end stop state, wheels 32 can no longer be further rotated about their respective axes 33 in a counterclockwise direction as seen in FIG. 1 (towards the left side of vehicle 22). In the right end stop state, wheels 32 can no longer be further rotated about their respective axes 33 in a clockwise direction as seen in FIG. 1 (towards the right side of vehicle 22). In the example illustrated, front wheels 32 have a smaller outer diameter than rear wheels 30 such that front wheels 32 may have a rotational speed greater than the rotational speed of rear wheels 30 to match the ground speed of rear wheels 30 when not skidding.

Vehicle braking system 36 comprises a system configured to independently brake wheels 30-R and 30-L to such an extent that either of wheels 30-R or 30-L may be locked against wheel rotation.

Steering wheel 38 comprises an input device by which an operator may turn and steer front wheels 32 between the end stop states and to the left and right end stop states. In some implementations, steering wheel 38 is provided as part of vehicle 22, positioned forward of or within an operator cab or other seating location. In some implementations, steering wheel 30 may be provided at a remote location. The angular position of steering wheel 38 corresponds to or may be mapped to an angular position of the steered front wheels 32 when the steered front wheels 32 are between the left and right end stop states/positions or at such end stop states or positions.

In the example illustrated, steering wheel 38 is illustrated as having been rotated about axis 40 in the direction indicated by arrow 42 to a steering wheel angular position that corresponds to the steered front wheels 32 being in a left end stop state in which wheels 32 can no longer be turned further towards the short turn side (to the left for a left turn). In the example being illustrated, arrow 44 corresponds to a 9 o′clock position of steering wheel 38 when vehicle 22 is steered in a straightforward direction. In the example being illustrated, steering wheel 38 has been turned in a counterclockwise direction from the forward straight position which results in wheels 32 also rotating in a counterclockwise direction to the angle shown. The angles shown are the most that the steered front wheels 32 may be turned to the left. At the end stop position or state of wheels 32, further attempts to rotate steering wheel 38 in the direction indicated by arrow 42 about axis 40 will not result in further turning of steering wheels 32 in the counterclockwise direction about axes 33-R, 33-L.

Although not shown, steering wheel 38 may be similarly rotated in a direction opposite to that of arrow 42 in a clockwise direction about axis 40. Such rotation will result in the steered wheels 32 rotating in a clockwise direction towards the right side of vehicle 22. Sufficient rotation of steering wheel 38 in the clockwise direction will result in steered wheels 32 being rotated to their maximum angular extent (right end stop state) such that further attempts to turn steering wheel 38 in the clockwise direction will not result in further turning of steered wheels 32. When steering wheel 38 is in this angular position, the steered front wheels 32 are at their right end stop positions or states.

Tight turn wheel locking system 20 comprises steering end stop sensor 50, end stop steering wheel input sensor 52, and controller 54. Steering end stop sensor 50 comprises at least one sensor configured to output signals indicating that steered front wheels 32 of vehicle 22 are in an end stop state towards the short turn side. FIG. 1 schematically illustrates three examples of sensing components of steering end stop sensor 50 which are shown in broken lines. Such individual sensing components shown in broken lines may be used in conjunction with one another, providing different ways of determining whether the steered front wheels 32 are in an end stop state and providing redundancy. In some implementations, steering end stop sensor 50 may comprise any individual one or otherwise less than all of the three options.

In some implementations, the steering end stop sensor 50 comprises a sensor configured directly sense in angular positioning of the steered front wheels. Such a sensor may involve one or more sensing elements. In some implementations, the steering end stop sensor 52 may comprise a wheel angle sensor 55 that senses a continuum of different possible angular positions of the steered front wheels 32 between a left turn end stop state and a right turn end stop state. One example of such a sensor is a potentiometer.

In some implementations, the end stop steering end stop sensor 50 may comprise a sensor that simply detects when the steered front wheels are at either of the left turn end stop state or the right turn end stop state. For example, such a steering end stop sensor may comprise a left contact switch 56-L for outputting signals when the steered front wheels are at a left turn end stop state and a right contact switch 56-R for outputting signals when the steered front wheels 32 are at a right turn end stop state. Such contact switches are mounted at locations such that the left contact switch 56-L is closed in response to wheels 32 being sufficiently turned so as to reach or attain a left turn end stop and such that the right contact switch 56-R is closed in response to wheels 32 being sufficiently turned so as to reach or attain a right turn end stop. Upon closure, the switch 56-L or 56-R outputs a signal indicating that the wheels 32 are in an end stop state.

In some implementations, the steering end stop sensor 50 may comprise a sensor that indirectly senses when the steered front wheels are at an end stop state, either a left turn end stop state, or a right turn end stop state. For example, between and including the left end stop state and the right end stop state of the steered front wheels, the angular positioning of the steering wheel 38 may directly correspond to or be mapped to the angular positioning of the steered front wheels 32. In some implementations, the steering end stop sensor 50 may comprise a steering wheel angle or position sensor 58 that directly senses an angular position of the steering wheel 38, thereby indirectly sensing or indicating the positioning of the steered front wheels 32 and outputting signals that may indicate whether the steered front wheels 32 are at either of the left turn end stop state or the right turn end stop state. In yet other implementations, the angular positioning of the steered front wheels and the determination of whether the steel front wheels are at either of the left end stop state or the right end stop state may be based upon other sensors that may directly or indirectly sense the angular positioning of the front steered wheels.

In some implementations, the rotational resistance of the steering wheel 38 is increased in response to the steered front wheels 32 of the vehicle 22 being in the end stop state towards the short turn side.

End stop steering wheel input sensor 52 is configured to output signals based upon operator interaction with the steering wheel 38 while the steered front wheels 32 are in either of the end stop states. This operator interaction is referred to as operator end stop input. This operator end stop input is evaluated by controller 54 to determine whether to enter the tight turn mode.

In some implementations, the steering wheel 38 is manually rotatable by a further amount against the rotational resistance while steered front wheels 32 are in an end stop state. In such an implementation, the end stop steering wheel input sensor 52 is configured to sense a velocity (or other angular rate of movement derived from the velocity) at which the steering wheel 38 is rotated while the steered front wheels 32 are in either the left or right end stop states. In such an implementation, the end stop operator input comprises the sensed velocity and is compared by controller 54 to a predefined velocity threshold value to determine whether vehicle 22 should enter the tight turn mode.

In some implementations, the steering wheel 38 is manually rotatable by further amount against the rotational resistance to a new angular position further towards the short turn side while the steered front wheels 32 are in the left end stop state or the right end stop state. In such an implementation, the end stop steering wheel input sensor 52 is configured to sense positioning of the steering wheel 38. The end stop operator input comprises the positioning of the steering wheel 38 relative to the new angular position which serves as the predetermined threshold for determining whether vehicle 22 should enter the tight turn mode.

For example, an operator may turn the steering wheel 38 to a first position corresponding to the steered front wheels 32 being in an end stop state towards the short turn side. Although the steering will may be further rotatable, the operator may experience an increased amount of resistance against such additional rotation or turning of the steering wheel 38. Such additional resistance may tactically indicate to the operator that further sharpening the turning angle of the vehicle 22 by turning the front steered wheels 32 is no longer available. Such additional resistance may indicate to the operator that any further rotation of the steering wheel 38 against the additional resistance is for the purpose of providing input to the vehicle 22 to cause the vehicle to enter into the tight turn mode. To trigger the tight turn mode, the operator may continue to turn the steering wheel 38 towards the short turn side, against the additional resistance, to a new second position beyond the first position. Turning of steering wheel 38 to the second position, against the increased turning resistance, results in the tight turn mode being automatically entered.

In some implementations, the additional rotational resistance applied to the steering wheel 38 upon the steered front wheels attaining an end stop state may prevent any further manual turning or rotation of the steering wheel 38 towards the current short turn side. In some implementations, the additional rotational resistance to further turning of the steering wheel 38 once the steered front wheels 32 have attained either the left end stop state or the right end stop state may be in the form of a simple mechanical end or stopping point. In other implementations, a nonmechanical rotational resistance (e.g., magnetic field or force) may be applied to an extent sufficient to block or impede any further manual turning or rotation of the steering wheel 38.

In such implementations, the operator may continue to apply force or rotational torque to the steering wheel 38 while the front steered wheels 32 are in the end stop state (while the steering wheel can no longer be further turned or rotated towards the short turn side). Such force will not result in further turning of the steering wheel 38. However, such force may be sensed, such as with an end stop steering wheel input sensor 52 in the form of a strain sensor. In such an implementation, the end stop operator input comprises this sensed force and is compared to a force value serving as a predetermined threshold to determine whether vehicle 22 should enter the tight turn mode.

In some implementations, such as when steering wheel 38 is part of a steer by wire system (also referred to as electronic power steering), steering wheel 38 may be further associated with a responsive force mechanism which applies resistance against turning of steering wheel 38. In such an implementation, the responsive force mechanism may comprise a tactile feedback device which includes components also serving as an angle sensor for serving as the steering wheel position sensor 58 and a velocity sensor for serving as the end stop steering wheel input sensor (where the operator input comprises a velocity of the steering wheel while the wheels 32 are in an end stop state). Examples of such a tactile feedback device include, but are not limited to, a 20 Nm TFD Steering Unit commercially available from Lord Corporation of Cary, North Carolina or similar steer by wire electronic power steering helms or units.

Controller 54 controls actuation or entry of vehicle 22 into a tight turn mode. Controller 54 may control additional operations of vehicle 22 as well. Controller 54 comprises processor 60 and memory 62. Processor 60 comprises a processing unit configured to carry out or follow instructions provided in memory 62.

Memory 62 comprises a non-transitory computer-readable medium providing such instructions for processor 60. Memory 62 may include integrated circuitry or software providing such instructions. Memory 62 includes instructions that direct processor 60 to carry out method 100 shown in FIG. 2.

As indicated by block 104 in FIG. 2, instructions in memory 62 direct processor 60 to sense and determine whether the steered wheels 32 of the vehicle 22 are in an end stop state towards the short turn side. As described above, such a determination may be made by controller 54 based upon signals received from wheel angle sensor 55, left and right contact switches 56 and/or steering wheel angular position sensor 58. In some implementations, each of such sensors may be used to provide redundancy and greater reliability. In other implementations, the determination may be made based upon a single sensor or single type of sensor. In some implementations, sensor 55, switches 56 or sensor 58 may be omitted.

As indicated by block 108, instructions in memory 62 direct processor 60 to sense end stop operator input to the steering wheel 38 of vehicle 22 while the steered wheels 32 are in the end stop state towards the short turn side. As described above, the end stop operator input may be in the form of the interaction of the operator with the steering wheel or the result of such interaction, all while or after the wheels 32 have reached an end stop state. As described above, the end stop operator input may be in the form of (1) a sensed velocity (including acceleration) of the steering wheel 38 further toward the short turn side after the wheels 32 have reached the end stop state, (2) a sensed new angular position of the steering wheel 38 further towards the short turn side, wherein movement of the steering will 38 further towards the short turn tide to the sensed new angular position occurred after the wheels 32 were at the end stop state or position, or (3) a sensed force exerted upon steering wheel 38 while the wheels 32 are in the end stop state.

As indicated by block 112 in FIG. 2, instructions in memory 62 further direct processor 60 to automatically enter a tight turn mode in response to the end stop operator input satisfying a predetermined threshold or predetermined criterion. For example, controller 54 may automatically enter the tight turn mode in response to (1) the sensed velocity of steering wheel 38 exceeding a predetermined velocity threshold, (2) the angular position of steering wheel 38 indicating that the steering wheel 38 has been rotated a sufficient distance after the point in time that wheels 32 reached an end stop position or (3) the sensed force or torque that steering wheel 38 is experiencing, when wheels 32 are in the end stop state, exceeding a predetermined force value threshold.

As indicated by block 116, in response to entering the tight turn mode, instructions contained in memory 62 may direct processor 60 to automatically output tight turn control signals that cause the vehicle braking system 36 to lock a rear wheel of the vehicle corresponding to the short turn side. In some implementations, vehicle 22 may additionally provide a notification to the vehicle operator that the tight turn mode has been triggered, such as with an audible notification, haptic notification or visual notification.

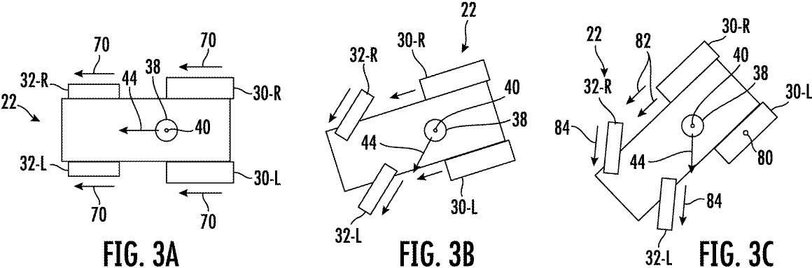

FIGS. 3A, 3B and 3C schematically illustrate an example of vehicle 22, provided with tight turn wheel locking system 20, being operated in a straight travel mode, a turning mode and a tight turn mode, respectively. In FIG. 3A, the propulsion system 26 of vehicle 22, whether it be a battery-powered electric propulsion system, an internal combustion engine propulsion system or combinations thereof, is propelling vehicle 22 in a forward direction. In the example illustrated, vehicle 22 is a multiple wheel drive vehicle wherein both the rear wheels 30 and the front wheels 32 may be rotatably driven. Arrow 44 (shown in FIG. 3A) is in its 9 o′clock position, pointing the same direction as arrows 70 in FIG. 3A. In other implementations, vehicle 22 may comprise a rear drive vehicle, wherein wheels 32 are not rotatably driven.

In FIG. 3B, vehicle 22 is in the turning mode in which vehicle 22 is continued to be propelled with wheels 30 and 32 both being rotatably driven. However, in FIG. 3B, steering wheel 38 has rotated about axis 40 so as to be aiming in the direction indicated by arrow 44 resulting in wheels 32 being turned in a counterclockwise direction about axes 33. FIG. 3B illustrates steering wheel 38 in an angular position (approximately the seven o′clock position) which corresponds to the wheels 32 being in a left turn end stop state in which wheels 32 have been rotated to a maximum extent such that wheels 32 may no longer be further rotated about axes 33 in the counterclockwise direction (towards the left side of the vehicle). At this point time, vehicle 22 is turning at an angle corresponding to the angle of front wheels 32.

In FIG. 3C, vehicle 22 has entered and is operating under the tight turn mode. As discussed above, entry into the tight turn mode is triggered based upon the sensed end stop operator input satisfying a predetermined threshold or criterion. When vehicle 22 is in the tight turn mode, controller 54 outputs tight turn control signals or braking signals that cause vehicle braking system 36 (shown in FIG. 1) to lock the short turn side rear wheel, wheel 30-L, in the example illustrated. Continued forward propulsion of vehicle 22 results in rear wheel 30-L skidding and pivoting about axis 80, resulting in an even tighter radius for vehicle 22. This tighter turning radius is sharper or smaller as compared to the turning radius being experienced by vehicle 22 in FIG. 3B (prior to entry into the tight turn mode). Depending on the underlying terrain or soil conditions, the locked wheel, wheel 30-L, may additionally translationally skid such that the pivot axis 80 may slightly translate during such tighter turning.

As schematically indicated by arrows 82, in some implementations, the rotational speed of the non-short turn side rear wheel (rear wheel 30-R in the example illustrated) may be incremented in the tight turn mode to further sharpen the turn and/or reduce the time for completing the turn. In some implementations, this increase rotational speed of the non-short turn side rear wheel is mechanically achieved with a rear wheel differential which substantially doubles the rotational speed of the non-short turn side rear wheel while the short turn side rear wheel is locked.

As schematically indicated by arrows 84, in some implementations, the rotational speed of the front steering wheels 32 may be incremented in the tight turn mode to further sharpen the turn and/or reduce the time for completing the turn. In some implementations, front wheels 32 may be overdriven at the same overdrive speed, provided with the same lead, independent of whether vehicle 22 is in or out of the tight turn mode. As discussed above, in some implementations, vehicle 22 may be provided with a front wheel overdrive system, permitting the rotational speed of the front wheels to be adjusted relative to the rotational speed of the rear wheels. As described above, some implementations, vehicle 22 may not be provided with such a front wheel overdrive system.

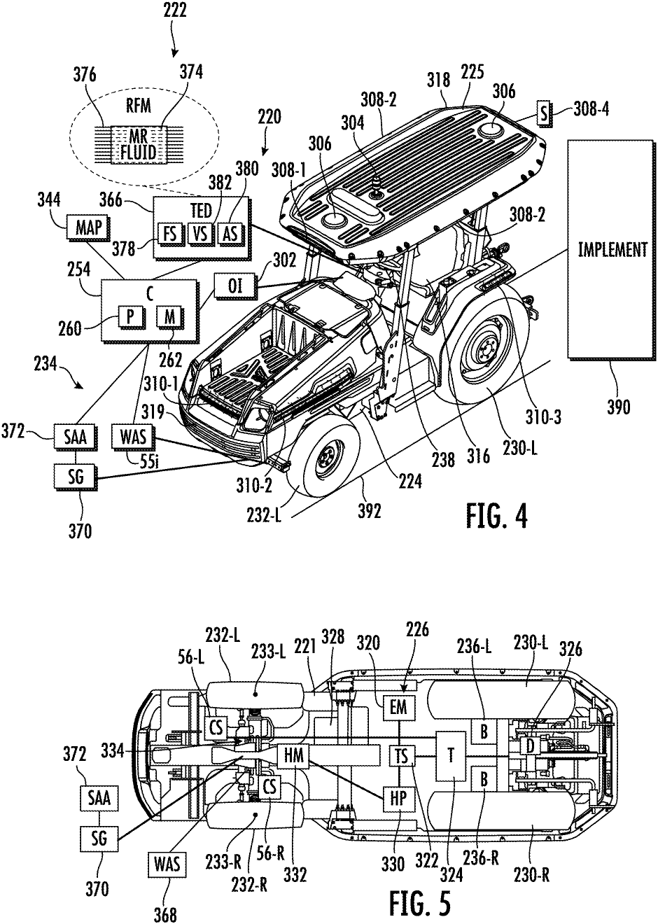

FIGS. 4, 5 and 6 illustrate portions of an example vehicle 222 provided with an example tight turn wheel locking system 220. FIGS. 4-6 illustrate an example of how the tighter turn braking system of FIG. 1 may be more specifically implemented in a particular example of a vehicle in the form of a tractor. FIGS. 4-6 further illustrate how the tight turn wheel locking system 220 may carry out the method 100 described above with respect to FIG. 2 with additional optional operational controls.

As shown by FIG. 4, vehicle 222 is in the form of a tractor and comprises frame 224, operator cab 225, propulsion system 226, rear wheels 230-R, 230-L (collectively referred to as rear wheels 230), steered front wheels 232-R, 232-L (collectively referred to as front wheels 232), steer by wire system 234, contact switches 56-R, 56-L (collectively referred to as contact switches 56) (described above), rear wheel brakes 236-R, 236-L (collectively referred to as brakes 236), operator input 302, global positioning system (GPS) antenna 304, inertial motion units 306, sensors 308-1, 308-2 and 308-4 (collectively referred to as sensors 308) and status indicators 310-1, 310-2 and 310-3 (collectively referred to as status indicators 310). Tight turn wheel locking system 220 utilizes portions of vehicle 222, including controller 254.

Frame 224 comprises a structure which supports the remaining components of vehicle 222. Frame 224 supports operator cab 225. Operator cab 225 comprises that portion of vehicle 222 in which an operator of vehicle 222 resides during use of vehicle 222. In the example illustrated, operator cab 225 comprises seat 316 and roof 318. Seat is beneath roof 318. Roof 318 supports GPS antenna 304 and sensors 308.

Propulsion system 226 serve to propel vehicle 222 in forward and reverse directions without turning or during turning. As shown by FIG. 5, propulsion system 226 comprises battery 319, electric motor 320, torque splitter 322, transmission, rear differential 326, transaxle 328, hydraulic pump 330, hydraulic motor 332 and front wheel transmission 334. Battery 319 comprises one or more battery modules which store electrical energy. Battery 319 is supported within an internal battery receiving cavity provided by frame 224. Battery 319 powers the electric motor 320.

Electrical motor 320 (schematically illustrated) outputs torque which is transmitted by a gearing to torque splitter 322. Torque splitter 322 transmits torque to transmission 324 and to hydraulic pump 330. Transmission 324 provides a plurality of forward and reverse gears providing different rotational speeds and torques to the rear wheels 230. Differential 326 comprises a set of driveshafts that cause the rotational speed of one shaft to be the average of the speeds of the other shafts or a fixed multiple of that average.

Transaxle 328 extends from transmission 324 and transmits torque to front wheel transmission 334 for rotatably driving the front steered wheels 232. Hydraulic pump 330 is driven by the torque provided by electric motor 320. Hydraulic pump 330 supplies pressurized hydraulic fluid to drive hydraulic motor 332. A hydraulic motor 332 supplies torque to front wheel transmission 334. This additional torque facilitates the rotatable driving of front wheels 232 at speeds that proportionally differ than the rotation speeds at which rear wheels 230 are being driven by transmission 324.

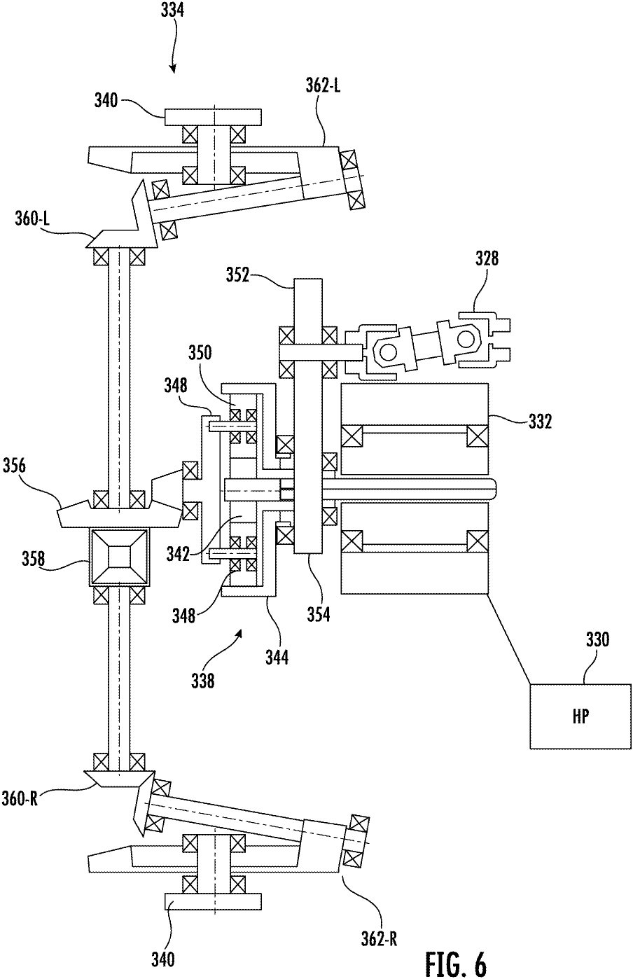

Front wheel transmission 334 delivers torque from one or both of transaxle 328 and hydraulic motor 332 to front wheels 232. FIG. 6 illustrates portions of one example propulsion system 226 including hydraulic pump 330, hydraulic motor 332 and planetary gear assembly 338. Hydraulic motor pump 330 powers hydraulic motor 332. In the example illustrated, hydraulic pump 330 comprises a continuous input variable displacement hydraulic piston pump. Hydraulic motor 332 comprises a modulation hydraulic motor.

Planetary gear assembly 338 combines torque from transaxle 328 and from hydraulic motor 332 and outputs the combined torque to front wheels 232 (shown In FIGS. 4 and 5) which are connected to front wheel flanges 340. Planetary gear assembly 338 comprises a sun gear 342, ring gear 344, and planet carrier 348 supporting planet gears 350 which intermesh with sun gear 342 and ring gear 344.

Sun gear 342 serves as a first input for planetary gear assembly 338. Sun gear 342 is connected to and receives torque from output shaft of hydraulic motor 332. Ring gear 344 serves as a second input for planetary gear assembly 338. Ring gear 344 is connected to transaxle 328 by a set of gears 352, 354. In other implementations, ring gear 344 may be connected to transaxle 328 by other transmission mechanisms such as belt and pulley arrangement or a chain sprocket arrangement. Planet carrier 348 is connected to gear set 356 and serves as an output for planetary gear assembly 338.

Gear set 356 comprises a pair of bevel gears connected to differential 358. Differential 358 outputs torque to gear sets 360-L and 360-R which further transmit torque to gear sets 362-L and 362-R which are connected to left and right wheel flanges 340.

FIGS. 4-6 illustrate one example of propulsion system 226. In other implementations, propulsion system 226 may have other forms or configurations. For example, in other implementations, propulsion system 226 may comprise other combinations of electric motors, hydraulic pumps and hydraulic in some implementations, vehicle propulsion system 226 may omit hydraulic systems. In some implementations, propulsion system 226 may omit electric motors, such as where vehicle propulsion system 226 relies upon an internal combustion engine for supplying torque directly to the transmissions or using hydraulic pumps and motors.

Rear wheels 230 extend at a rear portion of frame 224 of vehicle 222 and are not steerable while front wheels 232 extend at a front portion of the frame 224 and are steerable by steer by wire system 234.

Front wheels 232-R, 232-L are rotatably supported by frame 224 for rotation about pivot axes 233-R, 233-L, respectively. Front wheels 232 are steerable about axes 233-R, 233-L (collectively referred to as axes 233) in response to turning of steering wheel 238. Front wheels 232 are rotatable or steerable about axes 233 between left and right end stop states. In the left, or left turn, end stop state, wheels 232 can no longer be further rotated about their respective axes 233 further towards the short turn side, in a direction towards the left side of vehicle 222. In the right, or right turn, end stop state, wheels 232 can no longer be further rotated about their respective axes 233 towards the short turn side, in a direction towards the right side of vehicle 22. In the example illustrated, front wheels 32 have a smaller outer diameter than rear wheels 230 such that front wheels 232 may have a rotational speed greater than the rotational speed of rear wheels 230 to match the ground speed of rear wheels 230 when not skidding.

Steer by wire system 234 controls the steering of vehicle 222. Steer by wire system 234 comprises steering wheel 238, tactile feedback device 366, wheel angle sensor 55 (described above), steering gears 370, steering angle actuator 372 and controller 254. Steering wheel 238 comprises an input device by which an operator may turn and steer front wheels 232. In the example, steering wheel 238 is provided as part of vehicle 222, positioned within an operator cab 225, forward of seat 316. In other implementations, vehicle 222 may omit cab 225, seat 316 or steering wheel 238, wherein steering wheel 238 may be provided at a remote location. The angular position of steering wheel 238 corresponds to or may be mapped to an angular position of the steered front wheels 232 when the steered front wheels 232 are between the left and right end stop states/positions or are at such end stop states or positions.

Tactile feedback device 366 comprises a responsive force mechanism operably coupled to steering wheel 238 so as to provide a responsive resistance force against turning of steering wheel 238. As illustrated by broken lines, in the example illustrated, tactile feedback device 366 comprises a responsive force mechanism (RFM) in the form of a magnetic rheological fluid 374 and an electrically conductive coil 376. Fluid 374 is operably coupled to steering wheel 238. Electrically conductive coil 376 is configured to create a magnetic field around the fluid 374 to provide the resistance force against turning steering wheel 238. Controller 254 may be configured to output control signals controlling the flow of electrically conductive coil 376 to adjust the steering wheel turning resistance.

In the example illustrated, tactile feedback device 366 additionally serves as a sensing device. Tactile feedback device 366 includes components facilitating the use of tactile feedback device 366 as an angle sensor 380 and a velocity sensor 382. When serving as angle sensor 380, tactile feedback device 366 output signals indicating the angular position of steering wheel 238. When serving as a velocity sensor 382, tactile feedback device 366 output signals indicating the angular velocity or rotation of steering wheel 238. Examples of such a tactile feedback device include, but are not limited to, a 20 Nm TFD Steering Unit commercially available from Lord Corporation of Cary, North Carolina or similar steer by wire electronic power steering helms or units. In some implementations, the angular rate of rotation or rotational velocity may be determined by controller 254 based upon lapsed time and changes in the angular position of steering wheel 238 as indicated by angle sensor 380.

As further shown by FIG. 4, in some implementations, tactile feedback device 366 or vehicle 222 itself may be provided with a force sensor 378, such as a strain sensor, which may be configured to output signals indicating a sensed direct force being exerted upon steering wheel 238, such as after locking of steering wheel 238. In some implementations, force sensor 378 may be omitted.

Wheel angle sensor 55 comprise one or more sensors, such as potentiometers or the like, that sense the angular position of front wheels 232. Steering gears 370 comprise gears or other mechanism by which front wheels 232 may be rotated about axes 233. For example, in some implementations, steering gears 370 may comprise a rack and pinion gear arrangement. Steering angle actuator 372 comprises an actuator configured to drive steering gears 370 so as to adjust the angular positioning of front wheels 232. In some implementations, steering angle actuator 372 comprises an electric motor or a hydraulic motor (powered by a hydraulic pump).

Controller 254 intervenes between steering wheel 238 and steering angle actuator 372, forming the steer by wire functionality. Controller 254 controls the responsive force to provide the operator with tactile feedback to the rotation of steering wheel 238. Controller 254 further senses the angular positioning of steering wheel 238 and uses such information to output control signals causing steering angle actuator 372 to correspondingly or otherwise appropriately drive steering gears 370 to turn steering wheels 232 in accordance with rotation or positioning of steering wheel 238. Wheel angle sensor 55 may provide closed-loop feedback to controller 254 regarding the turning of front wheels 232 in response to steering control signals output by controller 254. In other implementations, the steer by wire system may have other configurations.

Contacts switches 56 comprise sensors that detect when the steered front wheels 232 are at either of the left turn end stop state or the right turn end stop state. Left contact switch 56-L outputs signals when the steered front wheels 232 are at a left turn end stop state and a right contact switch 56-R outputs signals when the steered front wheels 232 are at a right turn end stop state. Such contact switches are mounted at locations such that the left contact switch 56-L is closed in response to wheels 232 being sufficiently turned so as to reach or attain a left turn end stop and such that the right contact switch 56-R is closed in response to wheels 232 being sufficiently turned so as to reach or attain a right turn end stop. Upon closure, the switch 56-L or switch 56-R outputs a signal indicating that the wheels 232 are in an end stop state.

Brakes 236 are configured to independently brake wheels 230-R and 230-L to such an extent that either of wheels 230-R or 230-L may be locked against wheel rotation. In the example illustrated, brake 236-R brakes rear wheel 230-R while brake 236-L brakes rear wheel 230-L.

Operator input 302 (schematically illustrated) comprises one or more devices by which an operator residing in seat 316 or elsewhere may provide input and commands to vehicle 222. Operator input 302 may be in the form of a touchscreen, a monitor and mouse, keyboard, a touch pad, a joystick, a stylus pen, a toggle switch, slide bar, a microphone with speech recognition or the like.

Global positioning system (GPS) antenna 304 comprises an antenna situated upon roof 318 and provided as part of a larger global positioning satellite system, global navigation system (GNS) or other satellite-based radio navigation system. Antenna 304 may include an associated GPS receiver. GPS antenna 304 may be used by controller 254 to determine the geographical coordinates of vehicle 222.

Inertial motion units 306 comprises electronic devices that measure and report angular rate of movement, force and orientation of a body. Such inertial measurement units 306 may utilize a combination of accelerometers, gyroscopes and/or magnetometers. Inertial measurement units 306 may be used to calculate attitude. Signals from inertial motion units 306 may be used by controller 2542 calculator otherwise determine an orientation of vehicle 222, such as its pitch and/or roll.

Sensors 308-1, 308-2 and 308-4 (collectively referred to as sensors 308) are supported by roof 318 and are configured to sense and output signals indicating the surroundings of vehicle 222. Examples of sensors 308 include, but are not limited to, two-dimensional cameras, 3D stereoscopic cameras, light detection and ranging (LiDAR) sensors, infrared sensors and the like. Sensors 308 may output signals that may be used by a processor to identify obstructions or objects near vehicle 222, to identify the presence, type, state or other characteristics of an attached implement 390, to identify or evaluate the type or characteristics of the underlying soil or terrain 392, or for other functions. Signals from sensors 308 are transmitted to controller 254.

Status indicators 310-1, 310-2 and 310-3 (collectively referred to as status indicators 310) comprise devices configured to output or provide notifications to those individuals near vehicle 222. For example, in some implementations, vehicle 222 may be an automated vehicle that travels in the absence of an operator residing on seat 316. Vehicle 222 may be under robotic control. In some implementations, the operator vehicle 222 may be walking alongside vehicle 222 as it traverses a field. Indicators 310 may communicate information to the person based upon the color of light, the flashing frequency of light, the intensity of the light or so forth. Information may further be communicated with audible sound notifications. Such notifications may indicate the status of vehicle 222 or its operations. For example, status indicators 310 may indicate whether vehicle 222 is about to enter a tight turn mode or is in the tight turn mode.

Controller 254 comprises processor 260 and memory 262. Processor 260 comprises a processing unit configured to carry out or follow instructions provided in memory 262.

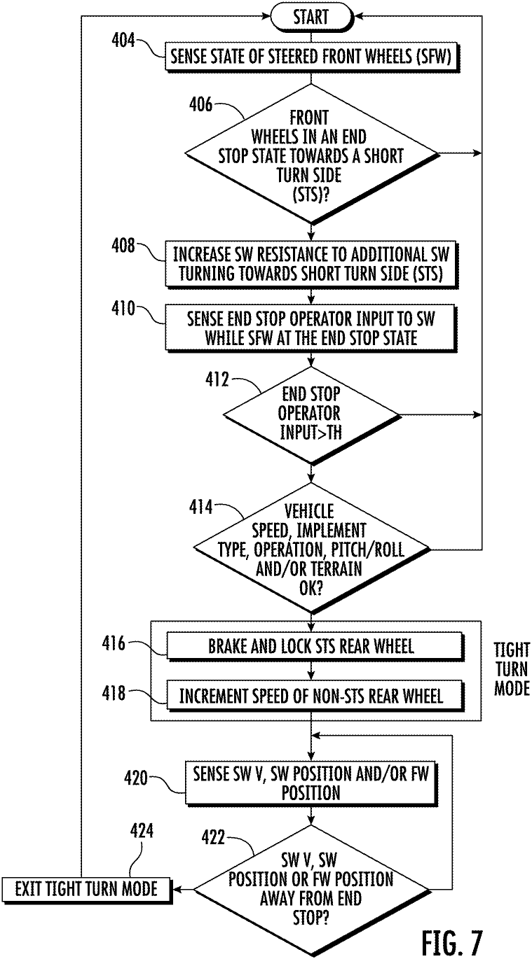

Memory 262 comprises a non-transitory computer-readable medium providing such instructions for processor 260. Memory 262 may include integrated circuitry or software providing such instructions. Memory 262 includes instructions for directing processor 260 to carry out control of propulsion system 226 and steer by wire system 234. In some implementations, controller 254 carries out automated or remote control of vehicle 222. In the example illustrated, memory 262 includes instructions that direct processor 260 to carry out method 400 shown in the flow diagram presented in FIG. 7.

As indicated by blocks 404 and 406 in FIG. 7, instructions contained in memory 62 direct processor 60 to sense and determine whether the steered front wheels 32 of vehicle 222 are in an end stop state towards a short turn side, either in a left or left turn end stop position when making a left turn or in a right or right turn end stop position when making a right turn. As indicated by block 404, the state of the steered front wheels (SFW) is sensed by steering end stop sensor.

In the example illustrated, vehicle 222 is equipped with three steering end stop sensors: wheel angle sensor 55, left and right contacts switches 56 and angle sensor 380, provided as part of tactile feedback device 366. In some implementations, controller 254 makes a determination that the front wheels 232 are in an end stop state based upon signals from each of the three different steering end stop sensors. Using multiple end stop sensors may facilitate a more reliable determination. In some implementations, the individual results from the individual steering end stop sensors may be differently weighted depending upon environmental conditions, reliability determinations and the like. In some implementations, the operator may select differently applied weightings or may which individual steering end stop sensor or combination of individual steering end stop sensors is to be utilized by controller 54 when determining whether front wheels 232 are in an end stop state.

Wheel angle sensor 55 is configured to directly sense angular positions of the steered front wheels 32. Such a sensor may involve one or more sensing elements. In some implementations, the steering end stop sensor 52 may comprise a wheel angle sensor 55 that senses a continuum of different possible angular positions of the steered front wheels 32 between a left turn end stop state and a right turn end stop state. One example of such a sensor is a potentiometer.

As discussed above, contact switches 56 detect when the steered front wheels are at either the left turn end stop state or the right turn end stop state. Left contact switch 56-L outputs signals when the steered front wheels are at a left turn end stop state. Right contact switch 56-R outputs signals when the steered front wheels 32 are at a right turn end stop state.

Angle sensor 380 comprises a sensor that indirectly senses when the steered front wheels are at an end stop state, either a left turn end stop state, or a right turn end stop state. For example, between and including the left end stop state and the right end stop state of the steered front wheels, the angular positioning of the steering wheel may directly correspond to or be mapped to the angular positioning of the steered front wheels. Steering wheel angle or position sensor 380 directly senses an angular position of the steering wheel 238, thereby indirectly sensing or indicating the positioning of the steered front wheels 232 and outputting signals that may indicate whether the steered front wheels 232 are at either of the left turn end stop state or the right turn end stop state. In yet other implementations, the angular positioning of the steered front wheels and the determination of whether the steel front wheels are at either of the left end stop state or the right end stop state may be based upon other sensors that may directly or indirectly sense the angular positioning of the front steered wheels.

As indicated by block 408, in response to a determination by controller 254 that the front wheels 232 are in an end stop state (at an end stop position), instructions contained in memory 262 may further direct processor 260 to output control signals causing the response force mechanism of tactile feedback device 360 to increase steering wheel resistance against any additional turning of steering wheel 238 towards the short turn side.

As indicated by block 410, instructions in memory 262 direct processor 260 to further sense end stop operator input to the steering wheel 238, interaction of the operator with the steering wheel 238 while the steered front wheels 32 are in an end stop state. As indicated by block 412, instructions in memory 262 further direct processor 260 to determine whether the sensed end stop operator input and satisfies a predetermined criterion or threshold TH.

In the example illustrated, system 220 and vehicle 222 provide an operator with the opportunity to select, using operator input 302, from amongst various options for sensing different forms of end stop operator input for triggering the tight turn mode. In a first operator selected mode, the steering wheel 238 is manually rotatable by a further amount against the rotational resistance while steered front wheels 232 are in an end stop state. In such an implementation, velocity sensor 382 senses a velocity (or other angular rate of movement derived from the velocity) at which the steering wheel 238 is rotated while the steered front wheels 232 are in either the left or right end stop states. In such an implementation, the end stop operator input comprises the sensed velocity and is compared by controller 254 to a predefined velocity threshold value to determine whether vehicle 222 should enter the tight turn mode.

In a second operator selected mode, the steering wheel 238 is manually rotatable by further amount against the rotational resistance to a new angular position further towards the short turn side while the steered front wheels 232 are in the left end stop state or the right end stop state. The end stop steering wheel input sensor 252 is configured to sense positioning of the steering wheel 238. The end stop operator input comprises the positioning of the steering wheel 38 relative to the new angular position which serves as the predetermined threshold for determining whether vehicle 222 should enter the tight turn mode.

For example, an operator may turn the steering wheel 238 to a first position corresponding to the steered front wheels 232 being in an end stop state towards the short turn side. Although the steering will may be further rotatable, the operator may experience an increased amount of resistance applied by the response force mechanism against such additional rotation or turning of the steering wheel 38. Such additional resistance may tactically indicate to the operator that further sharpening the turning angle of the vehicle 222 by turning the front steered wheels 232 is no longer available. Such additional resistance may indicate to the operator that any further rotation of the steering wheel 238 against the additional resistance is for the purpose of providing input to the vehicle 222 to cause the vehicle 222 to enter into the tight turn mode. To trigger the tight turn mode, the operator may continue to turn the steering wheel 238 towards the short turn side, against the additional resistance, to a new second position beyond the first position. Turning of steering wheel 238 to the second position, against the increased turning resistance, results in the tight turn mode being automatically entered.

In a third operator selected mode, the additional rotational resistance applied to the steering wheel 238 upon the steered front wheels attaining an end stop state may prevent any further manual turning or rotation of the steering wheel 238 towards the current short turn side. In some implementations, the additional rotational resistance to further turning of the steering wheel 238 once the steered front wheels 32 have attained either the left end stop state or the right end stop state may be in the form of a simple mechanical end or stopping point. In other implementations, a nonmechanical rotational resistance (e.g., magnetic field or force) may be applied to an extent sufficient to block or impede any further manual turning or rotation of the steering wheel 238. In such a mode, the operator may continue to apply force or rotational torque to the steering wheel 238 while the front steered wheels 232 are in the end stop state (while the steering wheel can no longer be further turned or rotated towards the short turn side). Such force will not result in further turning of the steering wheel 238. However, such force may be sensed, such as with an end stop steering wheel input sensor in the form of a strain sensor. In such an implementation, the end stop operator input comprises this sensed force and is compared to a force value serving as a predetermined threshold to determine whether vehicle 222 should enter the tight turn mode.

As indicated by block 414, prior to automatically entering the tight turn mode, controller 254 may verify that various other conditions or prerequisites are satisfied or exist for entry into the tight turn mode. Although illustrated as following the determination of whether the end stop operator input satisfies the predefined criteria or threshold, the determination of whether the other conditions or prerequisites are satisfied may occur at any time prior to entering the tight turn mode.

In some implementations, entry of the vehicle into the tight turn mode may be further predicated upon the current speed of the vehicle 222. For example, based upon signals from GPS antenna 304, propulsion system 226 or other conventional speed and velocity determination sensors or electronics, controller 254 may determine the speed of the vehicle 222. In circumstances where the speed of the vehicle is greater than a predetermined vehicle speed threshold, controller 254 may prevent entry of the vehicle into the tight turn mode. This may reduce the likelihood of vehicle overturn. In some implementations, the vehicle operator may be notified that for the tighter turn mode to be entered, the speed of the vehicle should be reduced.

In some implementations, entry of the vehicle into the tight turn mode may be based upon the type of implement or attachment connected to the vehicle. Based upon signals from a sensor, such as sensor 308-4, controller 254 may determine the parameters or characteristics of the implement/attachment 390 (schematically shown in FIG. 4). In some implementations, an image of the implement 390 may be captured and a neural network may be utilized to analyze the captured image to identify the attached implement 390. In some implementations, controller 254 may present a prompt on operator input 302 requesting the operator to indicate the type or characteristics of the implement/attachment. In such implementations, controller 254 may prevent entry into the tight turn mode in response to a determination that the vehicle is pulling a particular type of attachment or implement 390. For example, the particular type or attachment may have an insufficient drawbar length for such a tight turn mode.

In some implementations, entry of the vehicle into the tight turn mode may be additionally based upon the type of operation currently being carried out by the vehicle 222 or any attachments/implements 390. The vehicle 222 may include a sensor, such as sensors 308-4, that provide signals to controller 254 which determines the type of operation being carried out by the vehicle or any attachments/implements. In some implementations, controller 254 may determine the type or status of an operation based upon prior commands entered to vehicle 222 by the operator. In some implementations, controller 254 may present a prompt to the vehicle operator, using operator input 302, wherein the vehicle operator may provide an input indicating the type of operation being carried out. In such implementations, entry into the tight turn mode by the vehicle 222 may be prevented in response to a determination that the vehicle 222 or its implement 390 are carrying out a particular type of operation that might present safety concerns upon entry of the tight turn mode.

In some implementations, entry into the tight turn mode by the vehicle 222 may be prevented in response to determination that the current type of operation is at a rate or speed too high for entry into the tight turn mode. In some implementations, the operation of an attachment or implement 390 may be the height at which at least portions of the attachment or implement are currently being supported by the vehicle 222, wherein entry of the vehicle into the tight turn mode may be based upon or dependent upon the current height of the attachment or implement 390. For example, implement 390 may be supported at too great of a height relative to the ground or relative to the vehicle 222 for a tight turn mode to be exercised such that entry into the tight turn mode is automatically stopped or a notification is provided to the operator, the notification recommending that the tight turn mode not be entered. In some implementations, controller 254 may provide the vehicle operator with a notice, via operator input 302 (in the form of a touchscreen), providing the reason for the vehicle not entering the tight turn mode or may suggest to the operator that the speed, rate of the operation or height of the implement 390 be reduced to allow entry into the tight turn mode.

In some implementations, entry of vehicle 222 into the tight turn mode may be additionally based upon the current orientation of the vehicle 222, the current pitch and/or roll of the vehicle 222. For example, entry into the tight turn mode may be blocked in circumstances where the vehicle 222 has a pitch exceeding a predetermined pitch threshold to reduce likelihood of the vehicle overturning.

Controller 254 may determine or obtain the current pitch or roll of the vehicle 222 directly from operator input or from signals received from inertial motion units 306 that indicate the current orientation of the vehicle 222. In some implementations, the slope of the underlying terrain 392, which may correspond to or impact the pitch or roll of the vehicle, may be determined based on the GPS signals received by controller 254 from GPS antenna 304 and topographical maps 394. Such maps 394 may be stored on vehicle 222 or may be obtained in a wireless fashion from remote servers or sources. In such implementations, the determined slope of the terrain may be used to predict the pitch or other orientation of the vehicle so as to serve as a basis for preventing vehicle 222 from entering the tight turn mode. In some implementations, vehicle 222 may utilize sensors 308, such as cameras, carried by the vehicle 222 for determining the pitch or roll of the vehicle.

In some implementations, entry of the vehicle 222 into the tight turn mode may be additionally based upon the current type or characteristics of the underlying terrain on which the short turn side rear wheel is to skid during such a tight turn. Entry of vehicle 222 into the tight turn mode made to be dependent upon the type of soil and/or the moisture content of the underlying soil. Controller 254 may obtain the type of soil directly from operator input or may acquire characteristics of the underlying soil using global positioning system (GPS) signals acquired from GPS antenna 304 and indicating the current position of the vehicle 222 in combination with map data from a map 394 associating particular soil types or conditions with the current location of the vehicle 222. Such a map 394 may be stored on the vehicle or may be obtained in a wireless fashion from remote servers or sources. In some implementations, controller 254 may utilize sensors 308, such as cameras, carried by vehicle 222 for evaluating the type and current condition of the underlying soil or terrain.

In some implementations, system 220 provides the operator with the opportunity to select which, if any, of the aforementioned tight turn mode prerequisites, vehicle speed, implement type, operation status or characteristics, vehicle orientation (pitch/roll) or terrain are to be applied by controller 254. In some implementations, controller 254 may provide the operator with the opportunity to override a prerequisite.

In each of the aforementioned examples, in lieu of prohibiting or preventing entry of the vehicle 222 into the tight turn mode, such conditions may alternatively be used by the vehicle 222 as a basis for controlling the adjusted speed of the non-short turn side rear wheel, the incremental or adjusted the speed of the front wheels 232 during the tight turn mode, speed of the vehicle 222 during such a tight turn. For example, the current implement/attachment of the vehicle, the current operation of the vehicle and such or implement/attachment and/or the current type or characteristics of the underlying terrain 392 may each be used as a basis for adjusting the speed of the non-short turn side rear wheel or the adjustment of the speed of the front wheels during the tight turn mode. In some implementations, the speed of the vehicle to itself, although below the vehicle speed threshold (discussed above) may be used by the vehicle (system) as a basis for determining the increased speed of the non-short turn side rear wheel or the overdrive state of the front wheels 232. In some circumstances, the speed of the turning in the tight turn mode, such as the rotational speed of the non-short turn side rear wheel or the overdriven front wheels may be based on the current pitch or roll of the vehicle. In some implementations, such conditions may automatically cause the controller to reduce a speed of vehicle 222 or may cause the operator to be notified that the speed of the vehicle 222 should be reduced given the particular circumstances. In some implementations, when a prerequisite is not being satisfied, rather than preventing entry into the tight turn mode, controller 254 may automatically output control signals causing adjustment to the operational state of vehicle 222 and/or implement 390 so as to satisfy the prerequisite and permit entry into the tight turn mode.

As indicated by blocks 416 and 418, upon satisfaction of the prerequisite set forth in block 414, controller 254 and vehicle 222 enter the tight turn mode. As indicated by block 416, in response to entering the tight turn mode, instructions contained in memory 262 may direct processor 260 to automatically output tight turn control signals that cause the particular vehicle brake 236 on the short turn side to lock the particular rear wheel 230 of the vehicle corresponding to the short turn side. In some implementations, controller 254 may additionally provide a notification to the vehicle operator that the tight turn mode has been triggered, such as with an audible notification, haptic notification or visual notification.

As indicated by block 418, upon entry into the tight turn mode, the speed of the non-short turn side rear wheel may be incremented to further increase the speed of the short turn. In the example illustrated, the vehicle 222 is equipped with a rear axle differential 326 that automatically doubles the speed of the non-short turn side rear wheel in response to locking of the short turn side rear wheel.

As indicated by blocks 420 and 422, once vehicle 222 is in the tight turn mode, controller 254 continues to monitor operator input to the steering wheel to determine when to exit the tight turn mode. As indicated by block 420, (1) velocity sensor 382 may continue to sense the velocity of steering wheel 238, (2) angle sensor 380 may continue sense the angular position of steering wheel 238 and/or (3) wheel angle sensor 55 or contact switches 56 may indicate when wheels 232 are no longer in the prior end stop state.

As indicated by block 424, controller 254 may output control signals causing vehicle 222 to exit the tight turn mode based upon such further operator input to the steering wheel 238. For example, the operator may turn the steering wheel 238 in a direction away from the short turn side at a sufficient velocity, as sensed by velocity sensor 382, so as to satisfy a predetermined threshold which results in the tight turn mode being exited by controller 254. The operator may turn the steering wheel 238 in a direction away from the short turn side by a sufficient distance so as to satisfy in angular position or degree of rotation so as to satisfy a predefined threshold which results in the tight turn mode being exited by controller 254. Signals from wheel angle sensor 55 or contacts switches 56 may be used by controller 254 to indirectly sense the turning of steering wheel 238, whereby the position or angular velocity at which wheels 238 are turned may satisfy a predetermined threshold for the tight turn mode to be exited by controller 254. In some implementations, blocks 420 and 422 may be omitted, such as where the operator may provide an input using operator input 302 and requesting that the tight turn mode be exited.

To exit the tight turn mode, controller 254 outputs control signals releasing the previously locked short turn side rear wheel 230, permitting the previously locked short turn side rear wheel 230 to be rotationally driven once again. This may result in both wheels 230 having the same rotational speed due to differential 326. Any other operation adjustments carried out by controller 254 for the tight turn mode may be further discontinued or reversed.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A tight turn wheel locking system comprising:
a steering end stop sensor to output signals indicating that steered front wheels of a vehicle are in an end stop state towards a short turn side;
an end stop steering wheel input sensor to output signals indicating end stop operator input to the steering wheel while the steered front wheels are in the end stop state; and
a controller configured to automatically enter a tight turn mode in response to the end stop operator input satisfying a predetermined threshold,
wherein the controller, in the tight turn mode, outputs tight turn control signals that cause a vehicle braking system of the vehicle to lock a rear wheel of the vehicle corresponding to the short turn side.

2. The tight turn wheel locking system of claim 1, wherein the steering end stop sensor comprises a sensor configured to directly sense an angular positioning of the steered front wheels.

3. The tight turn wheel locking system of claim 1, wherein the steering end stop sensor comprises a sensor configured to directly sense an angular positioning of the steering wheel.

4. The tight turn wheel locking system of claim 1, wherein the controller is configured to increase a rotational resistance of the steering wheel in response to the steered front wheels of the vehicle being in the end stop state towards the short turn side.

5. The tight turn wheel locking system of claim 4, wherein the steering wheel is manually rotatable by a further amount against the rotational resistance while the front steered wheels are in the end stop state and wherein the end stop steering wheel input sensor is configured to sense a velocity at which the steering wheel is rotated while the front steered wheels are in the end stop state, the end stop operator input comprising the sensed velocity.

6. The tight turn wheel locking system of claim 4, wherein the steering wheel is manually rotatable against the rotational resistance to a new position further towards the short turn side while the front steered wheels are in the end stop state and wherein the end stop steering wheel input sensor is configured to sense positioning of the steering wheel, the end stop operator input comprising the comprising the positioning of the steering wheel and the predetermined threshold comprising the new position.

7. The tight turn wheel locking system of claim 4, wherein the steering wheel can no longer rotate towards the short turn side while the front steered wheels are in the end stop state towards the short turn and wherein the end stop steering wheel input sensor is configured to sense a force being applied to the steering wheel while the front steered wheels are in the end stop state, the end stop operator input comprising the sensed force.

8. The tight turn wheel locking system of claim 1, wherein the controller is further configured to:
compare a speed of the vehicle to a predetermined vehicle speed threshold; and
enter the tight turn mode only in response to the speed of the vehicle being less than the predetermined speed threshold.

9. The tight turn wheel locking system of claim 2, wherein the predetermined vehicle speed threshold is a speed value that is less than 7 miles per hour.

10. The tight turn wheel locking system of claim 5 further comprising:
a front wheel overdrive system,
wherein the controller is further configured to output front wheel overdrive signals that cause the front wheels to be driven at a speed that is based upon a speed at which a second rear wheel of the vehicle, opposite the short turn side, is being driven.

11. The tight turn wheel locking system of claim 1, wherein the controller is configured to enter into or operate in the tight turn mode based on a current type or condition of terrain underlying the vehicle.

12. The tight turn wheel locking system of claim 1, wherein the controller is configured to enter into or operate in the tight turn mode based on a current implement attached to the vehicle.

13. The tight turn wheel locking system of claim 1, wherein the controller is configured to enter into or operate in the tight turn mode based on a current operation being performed by the vehicle or an attached implement.

14. The tight turn wheel locking system of claim 1, wherein the controller is configured to enter into or operate in the tight turn mode based on a current pitch or roll of the vehicle.

15. The tight turn wheel locking system of claim 1 further comprising the vehicle comprising the steering wheel, front wheels, rear wheels including the rear wheel and a second rear wheel, and the braking system.

16. The tight turn wheel locking system of claim 1, wherein the vehicle further comprises:
a steering by wire system operably coupling the steering wheel to the front wheels of the vehicle for steering of the front wheels; and
a front wheel overdrive system, wherein the controller is further configured to output front wheel overdrive signals that cause the front wheels to be driven at a speed that is based upon a speed at which a second rear wheel of the vehicle, opposite the short turn side, is being driven.

17. The tight turn wheel locking system of claim 1, wherein the vehicle further comprises a rear differential and wherein the differential drives a second rear wheel at double a speed of the vehicle.

18. A method for executing a tighter turn using split braking, the method comprising:
sensing and determining whether steered wheels of a vehicle are in an end stop state towards a short turn side;
sensing end stop operator input to a steering wheel of the vehicle while the steered wheels are in the end stop state towards the short turn side; and
automatically entering a tight turn mode in response to the end stop operator input satisfying a predetermined threshold; and
in response to entering the tight turn mode, automatically locking a rear wheel of the vehicle corresponding to the short turn side.

19. The method of claim 18 further comprising:
comparing a speed of the vehicle to a predetermined vehicle speed threshold; and
automatically entering the tight turn mode only in response to the speed of the vehicle being less than the predetermined speed threshold.

20. The method of claim 18 further comprising entering into or operating in the tight turn mode bases on at least one of: a type of implement attached to the vehicle, a type or condition of terrain underlying the vehicle, a current operation being performed by the vehicle or an attached implement and a current pitch or roll of the vehicle.
